(19) United States
(12) Patent Application Publication
(10) Pub. No.: US 2010/0179980 A1
(43) Pub. Date: Jul. 15, 2010

(54) CACHE SYSTEM FOR MOBILE COMMUNICATIONS DEVICES

(75) Inventor: Domingo Lopez Montesdeoca, Madrid (ES)

Correspondence Address: FOLEY HOAG, LLP;PATENT GROUP, WORLD TRADE CENTER WEST, 155 SEAPORT BLVD, BOSTON, MA, 02110, US

(73) Assignee: MOVIDILO S.L., Madrid (ES)

(21) Appl. No.: 12/353,708

(22) Filed: Jan. 14, 2009

(51) Int. Cl. G06F 15/16

(52) U.S. Cl. 709/203

(57) ABSTRACT

A method is provided of executing an application on a wireless communications device operated by a user. The application includes a plurality of blocks, each of which has a plurality of resources. The wireless communications device communicates with a server over a wireless network. For each session, the method includes: (a) validating block definitions for blocks of the application stored on the wireless communications device with block information from the server; (b) prefetching given blocks of the application from the server; (c) validating one or more resources of blocks of the application stored on the wireless communications device with resources from the server; and (d) fetching resources not stored on the wireless communications device from the server when needed during execution of the application.

### BACKGROUND

The present application relates generally to mobile communications devices, and, more particularly, to a method and system for caching application content on such devices.

### BRIEF SUMMARY OF EMBODIMENTS OF THE INVENTION

In accordance with one or more embodiments of the invention, a method is provided of executing an application on a wireless communications device operated by a user. The application includes a plurality of blocks, each of which has a plurality of resources. The wireless communications device communicates with a server over a wireless network. For each session, the method includes: (a) validating block definitions for blocks of the application stored on the wireless communications device with block information from the server; (b) prefetching given blocks of the application from the server; (c) validating one or more resources of blocks of the application stored on the wireless communications device with resources from the server; and (d) fetching resources not stored on the wireless communications device from the server when needed during execution of the application.

In accordance with one or more embodiments of the invention, a computer program product is provided. The computer program product resides on a computer readable medium having a plurality of instructions stored thereon. The computer program product facilitates execution of an application on a wireless communications device operated by a user. The application includes a plurality of blocks, each of which has a plurality of resources. The wireless communications device communicates with a server over a wireless network. When the computer program product is executed by a processor on the wireless communications device, the processor is caused to: (a) validate block definitions for blocks of the application stored on the wireless communications device with block information from the server; (b) prefetch given blocks of the application from the server; (c) validate one or more resources of blocks of the application stored on the wireless communications device with resources from the server; and (d) fetch resources not stored on the wireless communications device from the server when needed during execution of the application.

In accordance with one or more embodiments of the invention, a system is provided for facilitating execution of applications on wireless communications devices. The applications include a plurality of blocks, each of which has a plurality of resources. The system includes: a plurality of wireless communications devices; and a server communicating with the wireless communications devices over a wireless network. For each session with a wireless communications device, the server (a) validates block definitions for blocks of the application stored on the wireless communications device with stored block information; (b) transmits given blocks of the application to the wireless communications device in a prefetch operation; (c) validates one or more resources of blocks of the application stored on the wireless communications device with resources from the server; and (d) transmits resources to the wireless communications device that are not stored on the wireless communications device in a fetch operation when needed during execution of the application.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram of a wireless communications system in accordance with one or more embodiments of the invention.

FIG. 2 is a simplified logical block diagram of an exemplary mobile client application platform in accordance with one or more embodiments of the invention.

FIG. 3 is a flow chart illustrating an exemplary method of caching application data on a mobile communications device in accordance with one or more embodiments of the invention.

### DETAILED DESCRIPTION

The present application relates to the execution of applications on wireless mobile communications devices. Such applications can be rich applications including, but not limited to, self-service applications that allow a user to perform self-service tasks with businesses without using human intermediaries, customer care applications, search applications, games, and marketing applications. These applications are hosted by a server and provided to the mobile devices remotely over a wireless network. In accordance with various embodiments of the invention, portions of applications are selectively cached on the mobile device such that they can be accessed directly from the local cache instead of from the server in order to reduce latency, i.e., the response time taken by the system to serve a request from the mobile device. By reducing latency, the usability of an application can be improved, and an improved browsing experience can be provided. In addition, caching portions of applications can reduce costs for the user by avoiding constant resource fetching, thereby reducing connection times and data transfer over wireless networks.

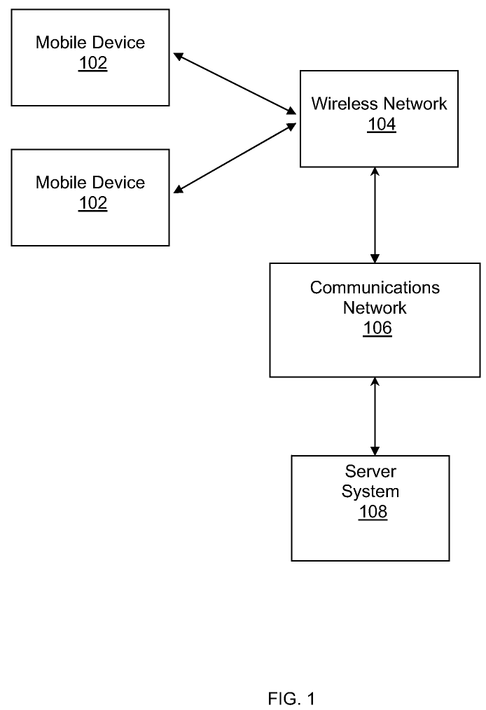

FIG. 1 is a block diagram of an exemplary communications system 100 in which various embodiments of the invention can be implemented. The system 100 includes a plurality of mobile communications devices 102, a wireless data network 104, a communications network 106, and a server system 108.

The mobile devices 102 can include a variety of portable computing devices capable of connecting to other computing devices and transmitting and receiving information. The mobile device 102 transmits information to and receives information from the server system 108 via the wireless data network 104 and the communications network 106. Examples of mobile devices 102 include portable devices such as, e.g., cellular telephones, smartphones, Personal Digital Assistants (PDAs), handheld computers, laptop computers, and the like.

The wireless data network 104 is configured to couple mobile devices 102 with the communications network 106. The wireless data network 104 can include any of a variety of networks including cellular communications networks, mesh networks, Wireless LAN (WLAN) networks, and the like. The wireless data network can further employ a plurality of access technologies including 2nd (2G), 3rd (3G) generation radio access for cellular systems, WLAN, Wireless Router (WR) mesh, and the like. Access technologies such as 2G, 3G, and future access networks can provide wide area coverage for mobile devices 102. For example, wireless data networks 104 can provide a radio connection through a radio network access such as Universal Mobile Telecommunications System (UMTS), Global System for Mobile communication (GSM), General Packet Radio Services (GPRS), Enhanced Data GSM Environment (EDGE), Wideband Code Division Multiple Access (WCDMA), and the like. In short, the wireless data network 104 can include virtually any wireless communication mechanism by which information may travel between mobile device 102 and another computing device, network, and the like, without limitation to any of the examples identified above.

The communications network 106 is configured to couple the server system 108 with other computing devices, including mobile devices 102, through the wireless network 104. The communications network 106 can be, e.g., the Internet, an intranet, or other network connection.

The mobile device and the server system can communicate using various communications protocols including, e.g., Hypertext Transfer Protocol (HTTP) or HTTPS, User-Datagram Protocol (UDP).

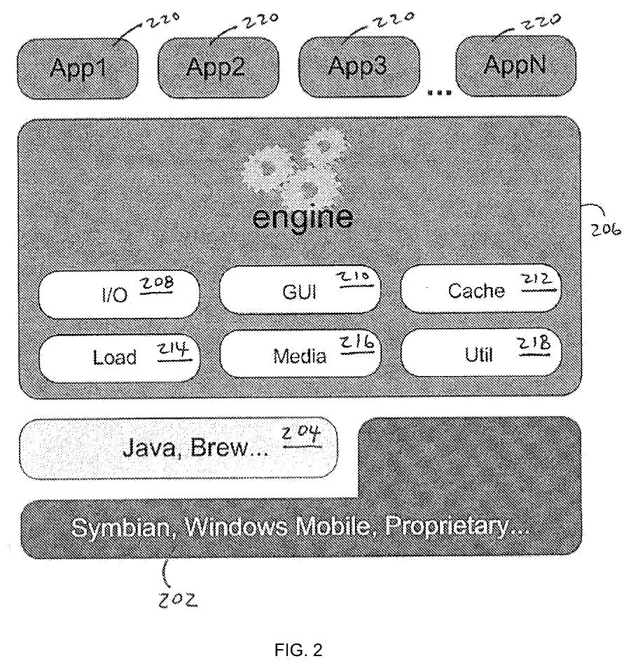

FIG. 2 is a simplified logical block diagram of an exemplary mobile client application platform stored in memory on a mobile device 102 in accordance with one or more embodiments of the invention. The mobile client application platform facilitates the running of applications 220 such as rich client applications received over wireless networks. The platform includes a resident operating system 202 such as, e.g., Symbian, Windows Mobile, Android, or a proprietary operating system. The operating system 202 controls the mobile device 102 and interacts with the hardware controlling access to the file system, memory, the central processing unit, transmission channels, and allocating resources.

The rich client applications 220 can optionally be coded in multimedia content description (MCD) language or format as described in a co-pending U.S. patent application entitled METHOD AND SYSTEM FOR PRESENTING CONTENT ON MOBILE COMMUNICATIONS DEVICES USING A MULTIMEDIA CONTENT DESCRIPTION LANGUAGE (Attorney Docket No. MOJ-00301) filed on even date herewith by the assignee of the present application, and which is incorporated by reference herein.

The mobile client application platform also includes an execution environment layer 204, which sits on the operating system. The execution environment layer can provide uniform access to dissimilar operating systems, which can be particularly convenient for application developers. Some environments like Java SE can permit access to the operating system, and others such as the Java ME platform preclude such access via a so-called sandbox.

The MCD engine 206 is a client-side platform installed on the mobile device to interpret one of more applications in MCD format received from the server in order to display the user interface content defined by the files on the mobile device. The MCD engine 206 includes a plurality of components providing support for processing MCD files, including an input-output module 208, a GUI (graphical user interface) module 210, a load library 214, media libraries 216 for audio and video processing, and utilities libraries 218. The MCD engine also includes cache libraries 212 for managing storage of frequently used content to reduce downloading over wireless networks. The cache libraries can include replacement policies, cache storage abstraction, and block management, which will be described in further detail below.

As used herein, an application session is a period of time starting when the user initiates the application and ending when the user finalizes this application run.

As used herein, a block is a logically defined portion of an application containing one or more resources. Resources can include content such as, e.g., images, fonts, audio, XML files, etc. Resources may belong to multiple blocks at the same time or they may belong to just one block. Some resources might even not be part of any block. Blocks are identified by unique identifiers with respect to other blocks in the application. Resources are also identified by unique identifiers such as a file path or URL (uniform resource locator).

In some embodiments, blocks of an application can be defined based on application usage patterns. For example, an application can have a main initial menu and some options branching from this main menu. In this example, the main menu portion of the application can be a block, and each of the different options from the main menu can be separate blocks. In another example, a block may contain a whole branch of an application (with one or more sub-menus and their associated content).

In some embodiments, blocks are defined logically based on the relationship among resources, the typical sequence of navigation, or any other criteria depending on the service in question. In some embodiments, information upon which to base block definitions can be automatically gathered from heuristics or navigation patterns and statistical data gathered by the system from a user or a determined set of users with a given behavioral profile. The blocks could be defined on a per user level, e.g., using the information collected on the user's navigation usage history to determine which kind of blocks allow a more effective usage of resources for that particular user.

In some embodiments, blocks are assigned priorities based on how important those blocks are to remain resident in cache. One possible criterion for prioritizing blocks could be assigning higher priority to blocks whose contents are more likely to be used by the client application, that is, a block can be considered to be a high-priority blocks based on, e.g., a high probability that the block would be used by the user. Examples of high probability blocks can include, e.g., an application main menu.

Servers hold two different types of information: the resources and the block definitions. Both of these change over the time. Block definitions describe how the blocks are composed, their unique identifiers, and the unique identifiers of the resources they include.

Both resources and block definitions can vary over the application existence. As newer content is updated, changed, or deleted into the application repository, a new content version is generated and a new version ID is associated automatically or by imposing some specific criteria. This identifier can follow a typical major-minor-micro convention or could well be any other sort of version numbering, like by using textual identifiers, names, natural numbers, etc.

As used herein, validation is the action of ensuring the correctness of the client cache as to block definitions and resources. Consequently, there are two kinds of validation: block definition validation and block resources validation. In every validation process, the server is provided some information on a given content version, and it compares the content version information with a possibly newer server content version, returning a validation report identifying any changes.

Block definition validation occurs only once per session and involves the process by which the entire block structure definition information is validated. The client informs the server about blocks for which it has a definition and also informs about the definition itself, that is, the identifiers of the resources they hold along with the content latest version associated with the block for which the resources have been validated. The server responds with a report on the variations that occurred between two versions, a possibly older version (provided by the client) and the latest content version (provided by the server). This report includes: identification of blocks that have been deleted, identification of new blocks, and identification of blocks that have been modified. A block definition is considered to have been modified if either of these two circumstances happens to be true: there have been changes (resource modification or deletion) between the two versions in any of the particular resources the block contains or the block in question has a different set of resources comparing both the newest and the oldest versions. After this validation, the client records the validation data in the cache along with the newest version number that from now until the end of the session will be considered the session version ID and that is to be handed over to the server in following sessions during block definition validation. All content shown to the user will remain coherent with this version number throughout the rest of the session. Blocks are marked as new or modified accordingly and the modification is characterized with the type of modification; whether some of its content modification has changed or not is recorded so as to retrieve them later as described below.

Resources validation refers to the validation of individual resources that belong to a given block. It takes place once the block definition validation described above has been completed. If a block is marked as modified and there has been a content modification, not a mere definition modification, or if it is marked as new in the aforementioned block definition validation, then its resources are to be validated. In this process, the client communicates the server the latest validated version for the block resources, the session version to validate against, and all the resource identifiers that the block contains in this version and that have been previously cached. The server informs back with a report that specifies which identifiers correspond to resources deleted, and then continues with downloading the binary data of those resources both new and modified and, in general, not outdated in the cache. Upon completion, the cached version for the block's resources is updated with the new binary payload data and the session content version is stored as the block version.

As used herein, resource fetching refers to the act of downloading a single resource for a given particular session version from the server to the client. When a resource is fetched, information is provided by the server regarding which block it pertains to, if there is any. The session version is handed over to the server and it, in turn, responds with the binary data.

As used herein, block prefetching refers to the act of prefetching the entire set of resources a given block comprises for a given content repository version from the server into the client. Block prefetching is performed through a block's resources validation. A session version is handed over to the server and it, in turn, responds with the binary data.

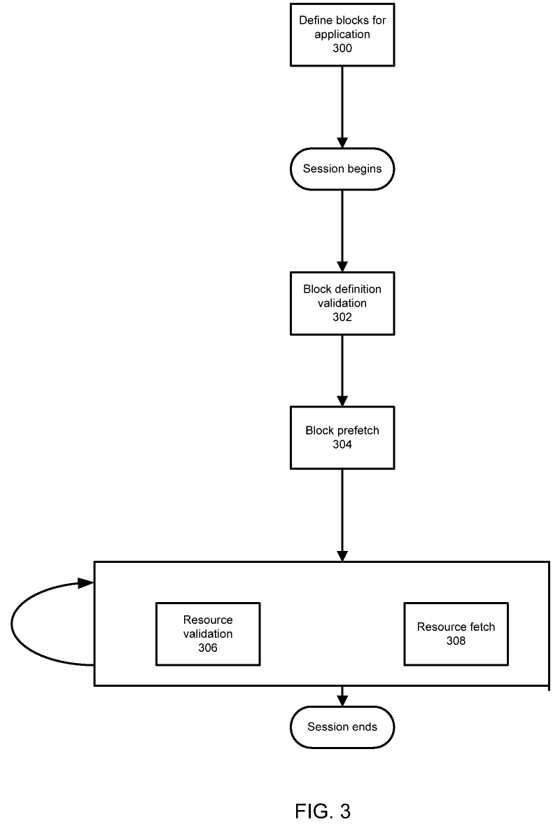

FIG. 3 illustrates an exemplary method by which an application can be executed on the mobile device 102 using the cache system in accordance with one or more embodiments of the invention. At step 300, an application is divided into a plurality of blocks.

Once session has started, at step 302, an initial one time operation is performed, in which block definitions stored on the mobile device are validated. As part of the process, the client is informed of the latest server repository version. This version will be the content version that will be used throughout the session regardless of any new content deployment in the server while this session is active. That is, if the server is updated with new application's contents, they only will become available for this particular user, after the session has expired. In the client, the current contents will be those defined with this version and no newer or older resources will be used.

At the same operation, in the step 304, the client can take advantage of the established connection to perform some block prefetching. One or more blocks of the application, usually, but not necessarily, those deemed to be high-priority blocks, are downloaded from the server to the mobile device, and stored in the cache, for later use.

At step 306, during execution of the application by the user on the mobile device, if the user navigates to parts of the application whose blocks have been marked as invalid either in step 302 or because some of its resources had to be dropped due to memory shortage, a determination is made as to which resources of the block have been changed, and only those resources are fetched from the server and substituted for the stored resources as described above with respect to resource validation. Substituting only the changed resources, as compared to entire blocks, improves the overall efficiency of the process.

At any moment, in step 308, resources can be fetched individually (as described above with respect to resource fetching) if required and cached inside its corresponding block if needed.

As indicated in the flowchart, steps 306 and 308 can be repeated during the session, until the session ends automatically, for instance due to an idle timeout or explicitly by the user.

The cache memory in the mobile device may be part of the device file system or, alternately it could be another type of non-volatile memory.

The main porting of the mobile client application platform can be based on a Java ME platform. It is not required that the Java ME have access to the lower file system, though there are some optional APIs available like the File System API that provides the functionality needed to perform such an access. Mobile phones such as, e.g., the Sony Ericsson W910 have this API implemented and can provide the mobile client application platform with the needed capabilities to store data in the file system. For other devices, a Record Management Store (RMS) can be used with appropriate code to store blocks of the application.

In general, the mobile client application platform can use the RMS unless any imposed restrictions, typically in size, of this memory system, make it so unreliable and limited that it does not lend itself to be used as a content storage.

One collateral effect of making use of the File System is that it is often shared by all sorts of applications and by the mobile user itself. Accordingly, this is typically controlled and supervised by the device operating system in order to protect the user from any malicious code that could erase or use the data inside the File System. Thus, security policies can apply and that can have an impact in the overall usage of the cache system since some permission is needed prior to the usage of this cache store.

The mobile client application platform can have two memory systems available, but a cache management module inside the mobile client application platform can be highly customizable and some other memory APIs can be plugged in the future, as needed. In some embodiments, the mobile client application platform stores its cached contents inside the RMS since it provides shorter access times and it is not subject to some security constraints as the shared File System does. RMS on the contrary, is not shared; typically only Java applications have access to it and only the mobile client application platform can gain access to the RMS reserved for the platform.

The mobile client application platform relies on validation to keep client content updated from the server. As illustrated below with respect to the described protocol, at the start of a session, the mobile device determines if the application blocks are valid and proceeds to validate the entire state. If the content is valid and up-to-date, then the cache stored, if any, in the mobile device, would be trusted and the content, if present, would be picked from the cache memory.

Validation can take place both initially and during the entire life cycle of the application. Thus, if any particular resource or content is dropped due to replacement activity, that is, if the cache ran out of space as described below, this content could be re-fetched from the server because the client would identify such a situation when performing validation in the runtime. As discussed above, the initial validation is performed at the block level, and for blocks identified to be invalid, resources within the blocks that have changed are updated when needed during execution of the application.

In accordance with one or more embodiments, the mobile client application platform can use HTTP headers to perform cache activities. HTTP headers can be useful for communicating data to the server such as version tags, block identifiers and so on.

In accordance with one or more embodiments, a replacement scheme is used when there is insufficient space in the mobile device cache to store downloaded blocks of the application. If the cache runs out of space, a choice must be made as to which content to delete from the cache so as to free space for new files to be stored. Various replacement policies can be used to determine which content is deleted.

In some embodiments, a priority scheme is applied to blocks of content. A priority level is assigned to each block. When a block is to be stored, and there is not enough memory room to make such operation, a lower priority block data is dropped from the memory.

As discussed above, blocks can be defined based on usage patterns. It is quite common, e.g., for an application to have a main initial menu and some options branching from this main menu. In such cases, it would be expected for the user to visit frequently the menu and the content that comes before the menu and then, branch to some of the following content derived from every single option in the menu. In this case, the content related to the main menu could form a block and a maximum or high priority would be given to this block (e.g., instructing the cache to never erase this block from memory). The other branches could be deemed lower priority blocks (some of which could have higher priority than others, depending on the forecasted usage pattern). When room is needed from the memory system, content from lower priority option blocks could be deleted from the cache to provide space for other blocks.

In some embodiments, the priority scheme is combined with other replacement policies. For example, a least recently used policy or a least frequently used policy can be used to discern among blocks are resources having the same priority.

Preferably, space in the cache is freed by removing only individual resources from stored blocks having lower priority. By deleting only resources within the blocks, efficiency is improved. For example, if in the next session, the user navigates through content pertaining to a lower priority block, the client will only need to download deleted resources and not the whole block.

If there is no lower priority block, or there is no space in the cache memory at all, then the pre-fetch would seamlessly be downgraded to a normal fetch mode. In such a situation, resources could be obtained on demand, without caching its containing blocks. It should be noted that in this case, while cache functionalities are downgraded, the version control system functionalities, which are described below, can still be present.

In accordance with one or more embodiments of the invention, a management system is provided for management of the cache for a multiple application environment, in which a plurality of applications coexist and are handled with a single instance of the mobile client application platform. In some embodiments, different management policies can be applied to different spaces or application contexts devoted to storing all the resources for each application running on application platform instance.

In some embodiments, a shared cache scheme is used in which every application shares the total space in the device, rather than having an assigned dedicated storage space for each application. The shared cache is typically used only for applications cached in accordance with various embodiments of the invention. These applications will be isolated from other applications such as, e.g., a browser, which is cached separately.

In some embodiments, each application is assigned a dedicated storage space in the cache. In this case, if one particular application needs more storage space but it has no more free space in its cache, it will downgrade to a simple fetching process. Alternatively, parts of the individual caches could be shared, up to a certain amount. In this case, if after freeing the cache for a particular application, there is still a need for space, some space from the cache of another application (e.g., the least recently used application) could be used up to a predetermined limit. In this way, the pre-fetching techniques described herein can still be used.

With respect to freeing space, in some embodiments, resources from any application could be replaced by an application needing additional space. In other embodiments, only the resources of the application that needs space can be replaced, i.e., without affecting other applications.

A version control system is provided in accordance with one or more embodiments of the invention to maintain version coherency. Applications executed on the mobile devices can be subject to version changes during execution of the application. When a particular content or part of an application needs to be changed (e.g., the functionality is updated, the design is changed, or a scripting change is fixed), the version control system makes the version change process transparent for the user. With the version control system, the user will experience a uniform coherent navigation throughout a single session. It avoids the situation where a user is exposed to a mixture of outdated content and new content in a single session or a single application run, providing an inconsistent experience.

An exemplary illustration of version control implemented in the server and client is as follows. Versions are numbered in the usual major, minor, micro way, e.g., first version would be 0.0.1, second could be 1.0.0, and so on. Assume content developers start a content update for an application. In a common scenario, in the precise time that the content is being uploaded and the last version modified, say, from version 0.0.1 to version 1.0.0, a large number of users could be using and accessing the application, and validating and downloading content from the server.

The mobile client application platform makes changes automatically to the entire content repository and in doing so, the following rule applies: a user always browses one single version in a particular run or execution of an application.

New versions are automatically checked upon application start. The next time the user starts up the application, the new 1.0.0 version would take on the older 0.0.1.

The mobile client application platform can thus use tagging mechanisms to avoid content incoherence and to provide the user with a consistent experience regardless the timing used to apply changes in the server repository.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, e.g., in hardware, software, firmware, or any combination thereof.

Claims set forth below having steps that are numbered or designated by letters should not be considered to be necessarily limited to the particular order in which the steps are recited.

Having described preferred embodiments of the present invention, it should be apparent that modifications can be made without departing from the spirit and scope of the invention.

What is claimed is:

1. A method of executing an application on a wireless communications device operated by a user, the application comprising a plurality of blocks, each of the blocks having a plurality of resources, said wireless communications device communicating with a server over a wireless network, the method comprising:
(a) validating block definitions for blocks of the application stored on the wireless communications device with block information from the server;
(b) prefetching given blocks of the application from the server;
(c) validating one or more resources of blocks of the application stored on the wireless communications device with resources from the server; and
(d) fetching resources not stored on the wireless communications device from the server when needed during execution of the application.

2. The method of claim 1, wherein said given blocks prefetched from the server are high-priority blocks.

3. The method of claim 2 wherein the high-priority blocks comprise a user interface menu.

4. The method of claim 1 wherein the blocks are prioritized, and resources of a block having a lower priority are deleted from memory in the wireless communications device so that resources of other blocks can be stored in the memory when there is insufficient space in the memory.

5. The method of claim 1 wherein resources of a least recently used block or a least frequently used block are deleted from the memory so that resources of other blocks can be stored in the memory when there is insufficient space in the memory.

6. The method of claim 1 wherein blocks of a plurality of applications are stored on the wireless communications device and the plurality of applications share a common cache.

7. The method of claim 1 wherein blocks of a plurality of applications are stored on the wireless communications device, and each of the plurality of applications is assigned a dedicated cache.

8. The method of claim 1 wherein if the application is changed in the server during execution of the application on the wireless communications device, the user is provided with blocks of the application from the server that are consistent with the version being executed on the mobile device.

9. The method of claim 1 wherein said blocks are defined based on application usage patterns.

10. The method of claim 1 wherein validating block definitions comprises receiving from the server an identification of blocks that have been deleted, modified, or added.

11. The method of claim 1 wherein validating one or more resources comprises transmitting to the server resource identifiers and a session version to validate against, and further comprises receiving from the server binary data of new or modified resources.

12. A computer program product residing on a computer readable medium having a plurality of instructions stored thereon, said computer program product for facilitating execution of an application on a wireless communications device operated by a user, the application comprising a plurality of blocks, each of the blocks having a plurality of resources, said wireless communications device communicating with a server over a wireless network, wherein when said computer program product is executed by a processor on said wireless communications device, the processor is caused to:
(a) validate block definitions for blocks of the application stored on the wireless communications device with block information from the server;
(b) prefetch given blocks of the application from the server;
(c) validate one or more resources of blocks of the application stored on the wireless communications device with resources from the server; and
(d) fetch resources not stored on the wireless communications device from the server when needed during execution of the application.

13. The computer program product of claim 12, wherein said given blocks prefetched from the server are high-priority blocks.

14. The computer program product of claim 13 wherein the high-priority blocks comprise a user interface menu.

15. The computer program product of claim 12 wherein the blocks are prioritized, and further comprising instructions for deleting resources of a block having a lower priority from memory in the wireless communications device so that resources of other blocks can be stored in the memory when there is insufficient space in the memory.

16. The computer program product of claim 12 wherein resources of a least recently used block or a least frequently used block are deleted from the memory so that resources of other blocks can be stored in the memory when there is insufficient space in the memory.

17. The computer program product of claim 12 wherein validating block definitions comprises receiving from the server an identification of blocks that have been deleted, modified, or added.

18. The computer program product of claim 12 wherein validating one or more resources comprises transmitting to the server resource identifiers and a session version to validate against, and further comprises receiving from the server binary data of new or modified resources.

19. A system for facilitating execution of applications on wireless communications devices, the applications comprising a plurality of blocks, each of the blocks having a plurality of resources, said system comprising:
a plurality of wireless communications devices; and
a server communicating with the wireless communications devices over a wireless network, wherein for each session with a wireless communications device, the server (a) validates block definitions for blocks of the application stored on the wireless communications device with stored block information; (b) transmits given blocks of the application to the wireless communications device in a prefetch operation; (c) validates one or more resources of blocks of the application stored on the wireless communications device with resources from the server; and (d) transmits resources to the wireless communications device that are not stored on the wireless communications device in a fetch operation when needed during execution of the application.

20. The system of claim 19, wherein said given blocks prefetched from the server are high-priority blocks.

21. The system of claim 20 wherein the high-priority blocks comprise a user interface menu.

22. The system of claim 19 wherein the blocks are prioritized, and resources of a block having a lower priority are deleted from memory in the wireless communications device so that resources of other blocks can be stored in the memory when there is insufficient space in the memory.

23. The system of claim 19 wherein resources of a least recently used block or a least frequently used block are deleted from the memory so that resources of other blocks can be stored in the memory when there is insufficient space in the memory.

24. The system of claim 19 wherein blocks of a plurality of applications are stored on the wireless communications device and the plurality of applications share a common cache.

25. The system of claim 19 wherein blocks of a plurality of applications are stored on the wireless communications device, and each of the plurality of applications is assigned a dedicated cache.

26. The system of claim 19 wherein if the application is changed in the server during execution of the application on the wireless communications device, the user is provided with blocks of the application from the server that are consistent with the version being executed on the mobile device.

27. The system of claim 19 wherein said blocks are defined based on application usage patterns.

28. The system of claim 19 wherein validating block definitions comprises receiving from the server an identification of blocks that have been deleted, modified, or added.

29. The system of claim 19 wherein validating one or more resources comprises transmitting to the server resource identifiers and a session version to validate against, and further comprises receiving from the server binary data of new or modified resources.
